(19) United States
(12) Patent Application Publication
(10) Pub. No.: US 2026/0024320 A1
(43) Pub. Date: Jan. 22, 2026

(54) SEMANTIC SEGMENTATION MODEL TRAINING METHOD, ELECTRONIC DEVICE AND STORAGE MEDIUM

(71) Applicant: Beijing Zitiao Network Technology Co., Ltd., Haidian District, Beijing (CN)

(72) Inventors: Jie QIN, Beijing (CN); Jie WU, Beijing (CN); Xuefeng XIAO, Beijing (CN)

(21) Appl. No.: 18/993,309

(22) PCT Filed: Jun. 30, 2023
(86) PCT No.: PCT/CN2023/104527

§ 371 Date: Jan. 10, 2025

(30) Foreign Application Priority Data
Jul. 11, 2022 (CN) 202210853729.8

(51) Int. Cl. G06V 10/774; G06V 10/26; G06V 10/44; G06V 10/776; G06V 20/70

(52) U.S. Cl. CPC G06V 10/7747; G06V 10/26; G06V 10/44; G06V 10/776; G06V 20/70

(57) ABSTRACT

A semantic segmentation model training method and apparatus, an electronic device and a storage medium are provided. The semantic segmentation model training method includes: acquiring a sample image, and extracting visual image features corresponding to the sample image by a semantic segmentation model to be trained; processing the sample image to obtain a text image feature corresponding to the sample image, the text image feature being an image feature generated from language description text for the sample image; fusing the visual image features with the text image feature to obtain multimodal features, and performing image segmentation prediction based on the multimodal features to obtain a target loss; and training the semantic segmentation model to be trained based on the target loss to obtain a target semantic segmentation model.

### CROSS-REFERENCE TO RELATED APPLICATION

The present disclosure claims priority of the Chinese Patent Application No. 202210853729.8, entitled “semantic segmentation model training method and apparatus, electronic device and storage medium” and filed with the Chinese Patent Office on Jul. 11, 2022, the entire disclosure of which is incorporated by reference in the present disclosure.

### TECHNICAL FIELD

Embodiments of the present disclosure relate to the technical field of image processing, in particular to a semantic segmentation model training method and apparatus, an electronic device and a storage medium.

### BACKGROUND

Image semantic segmentation is the technique of identifying the content in images to segment objects that represent different meanings into distinct targets. This technique is commonly achieved by utilizing pre-trained semantic segmentation models to perform semantic segmentation on images and is extensively applied in various applications.

In the related art, the semantic segmentation model is trained by acquiring sample images and learning the visual information in the sample images, so that the trained model can perform semantic segmentation based on the visual information in input images.

### SUMMARY

The embodiments of the present disclosure provide a semantic segmentation model training method and apparatus, an electronic device and a storage medium.

In a first aspect, the embodiments of the present disclosure provide a semantic segmentation model training method, including:

acquiring a sample image, and extracting visual image features corresponding to the sample image by a semantic segmentation model to be trained; processing the sample image to obtain a text image feature corresponding to the sample image, the text image feature being an image feature generated from language description text for the sample image; fusing the visual image features with the text image feature to obtain multimodal features, and performing image segmentation prediction based on the multimodal features to obtain a target loss; and training the semantic segmentation model to be trained based on the target loss to obtain a target semantic segmentation model.

In a second aspect, the embodiments of the present disclosure provide an image semantic segmentation method, including:

acquiring a target image; extracting visual image features and a text image feature corresponding to the target image, the text image feature being an image feature generated from language description text for the target image; and fusing the visual image features with the text image feature to obtain multimodal features, and performing image segmentation based on the multimodal features to obtain an image segmentation result.

In a third aspect, the embodiments of the present disclosure provide a semantic segmentation model training apparatus, including:
a vision module, configured to acquire a sample image, and extract visual image features corresponding to the sample image by a semantic segmentation model to be trained;
a text module, configured to process the sample image to obtain a text image feature corresponding to the sample image, the text image feature being an image feature generated from language description text for the sample image;
a fusion module, configured to fuse the visual image features with the text image feature to obtain multimodal features, and perform image segmentation prediction based on the multimodal features to obtain a target loss; and
a training module, configured to train the semantic segmentation model to be trained based on the target loss to obtain a target semantic segmentation model.

In a fourth aspect, the embodiments of the present disclosure provide an image semantic segmentation apparatus, including:
an acquisition module, configured to acquire a target image;
an extraction module, configured to extract visual image features and a text image feature corresponding to the target image, the text image feature being an image feature generated from language description text for the target image;
a segmentation module, configured to fuse the visual image features with the text image feature to obtain multimodal features, and perform image segmentation based on the multimodal features to obtain an image segmentation result.

In a fifth aspect, the embodiments of the present disclosure provide an electronic device, including:
a processor and a memory communicating with the processor,
in which the memory stores computer-executed instructions, and
the processor executes the computer-executed instructions stored in the memory, so as to implement the semantic segmentation model training method described in the first aspect and various possible designs of the first aspect as above; or to implement the image semantic segmentation method described in the second aspect and various possible designs of the second aspect as above.

In a sixth aspect, the embodiments of the present disclosure provide a computer-readable storage medium, in which computer-executed instructions are stored in the computer-readable storage medium, and when the computer-executed instructions are executed by a processor, the semantic segmentation model training method described in the first aspect and various possible designs of the first aspect as above is implemented, or the image semantic segmentation method described in the second aspect and various possible designs of the second aspect as above is implemented.

In a seventh aspect, the embodiments of the present disclosure provide a computer program product, including computer programs, in which the computer programs, when executed by a processor, implement the semantic segmentation model training method described in the first aspect and various possible designs of the first aspect as above; or implement the image semantic segmentation method described in the second aspect and various possible designs of the second aspect as above.

In an eighth aspect, the embodiments of the present disclosure provide a computer program for implementing the semantic segmentation model training method described in the first aspect and various possible designs of the first aspect as above; or implementing the image semantic segmentation method described in the second aspect and various possible designs of the second aspect as above.

The semantic segmentation model training method and apparatus, electronic device and storage medium provided by embodiments of the present disclosure, include: acquiring a sample image, and extracting visual image features corresponding to the sample image by a semantic segmentation model to be trained; processing the sample image to obtain a text image feature corresponding to the sample image, the text image feature being an image feature generated from language description text for the sample image; fusing the visual image features with the text image feature to obtain multimodal features, and performing image segmentation prediction based on the multimodal features to obtain a target loss; and training the semantic segmentation model to be trained based on the target loss to obtain a target semantic segmentation model. In the process of training the model, on the basis of the visual features of the sample image, the text feature of the sample image is fused to generate the multimodal features, and the multimodal features are used to train the model, so that effective information in the sample image is more fully utilized.

### BRIEF DESCRIPTION OF DRAWINGS

In order to more clearly illustrate the technical solutions in the embodiments of the present disclosure or in related art, the drawings to be used in the description of the embodiments or prior art will be briefly described below. Obviously, the drawings in the following description are only some embodiments recorded in the present disclosure. For those ordinarily skilled in the art, other drawings may be obtained based on these drawings without inventive work.

FIG. 1 is a diagram of an application scenario of a semantic segmentation model training method according to an embodiment of the present disclosure;

FIG. 2 is a first flowchart of a semantic segmentation model training method according to an embodiment of the present disclosure;

FIG. 3 is a flowchart of specific implementation of step S102 in the embodiment shown in FIG. 2;

FIG. 4 is a schematic diagram of a process of processing a sample image based on a first text model according to an embodiment of the present disclosure;

FIG. 5 is a schematic diagram of a process for acquiring a target loss according to an embodiment of the present disclosure;

FIG. 6 is a second flowchart of a semantic segmentation model training method according to an embodiment of the present disclosure;

FIG. 7 is a schematic diagram of a semantic segmentation model to be trained according to an embodiment of the present disclosure;

FIG. 8 is a flowchart of specific implementation of step S209 in the embodiment shown in FIG. 6;

FIG. 9 is a structural block diagram of a semantic segmentation model training apparatus according to an embodiment of the present disclosure;

FIG. 10 is a structural schematic diagram of an electronic device according to an embodiment of the present disclosure; and

FIG. 11 is a schematic diagram of a hardware structure of an electronic device according to an embodiment of the present disclosure.

### DETAILED DESCRIPTION

In order to make the objectives, technical solutions, and advantages of the embodiments of the present disclosure clearer, the technical solutions in the embodiments of the present disclosure will be described clearly and completely below in conjunction with the drawings. Apparently, the described embodiments are just a part but not all of the embodiments of the present disclosure. All other embodiments obtained by those ordinary skilled in the art without any creative effort based on the embodiments of the present disclosure fall within the scope of the present disclosure.

The application scenario of an embodiment of the present disclosure will be explained below.

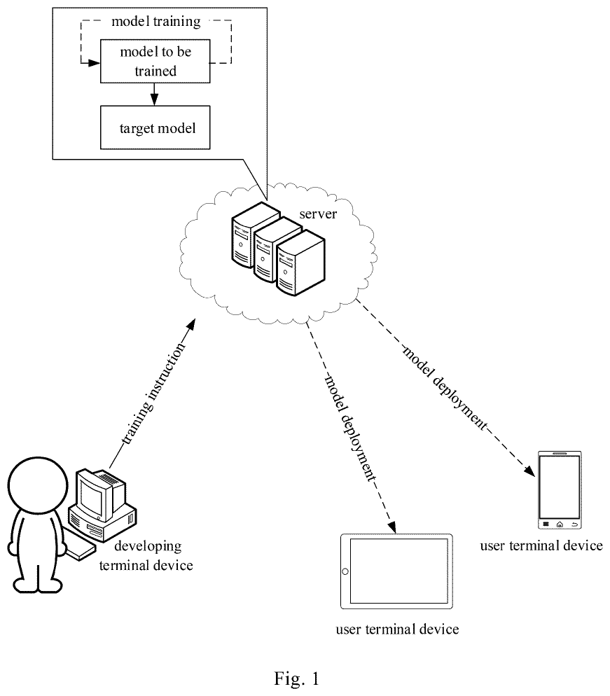

FIG. 1 is a diagram of an application scenario of a semantic segmentation model training method according to an embodiment of the present disclosure. The semantic segmentation model training method provided by the embodiment of the present disclosure may be applied to an application scenario of model training before a semantic segmentation model is deployed. Specifically, the method provided by the embodiment of the present disclosure may be applied to devices used for model training, such as terminal devices and servers. FIG. 1 uses a server as an example, and as shown in FIG. 1, a semantic segmentation model to be trained (shown as a model to be trained in the figure) is configured in the server. The server receives a training instruction sent by a developer user by a developing terminal device, and uses the semantic segmentation model training method provided by the embodiment of the present disclosure to train the model to be trained until a model convergence condition is met, so as to obtain a target semantic segmentation model (shown as a target model in the figure). After that, the server receives a deployment instruction (not shown in the figure) sent by a terminal device, and deploys the model, that is, deploys the target semantic segmentation model to the user terminal device. After the deployment is completed, the target semantic segmentation model running in the user terminal device may respond to an application request to provide the service for image semantic segmentation.

In the related art, the image semantic segmentation model is trained by acquiring sample images and performing feature extraction and learning on the images at the visual feature level, so that the trained model can complete the image segmentation task based on cues at the visual feature level. However, as images convey rich information, solely learning by extracting visual features from the sample images leads to the loss of some valuable information in the sample images, resulting in a low utilization rate of information within the sample images and the need for more training samples, thus leading to low overall training efficiency of the model and poor performance of the trained model.

The embodiment of the present disclosure provides a semantic segmentation model training method, by acquiring visual features of sample images and combining a text feature of the sample images for feature fusion to obtain multimodal features, and then training a model based on the multimodal features to enhance the utilization of information in the sample images, can solve the above-mentioned problems.

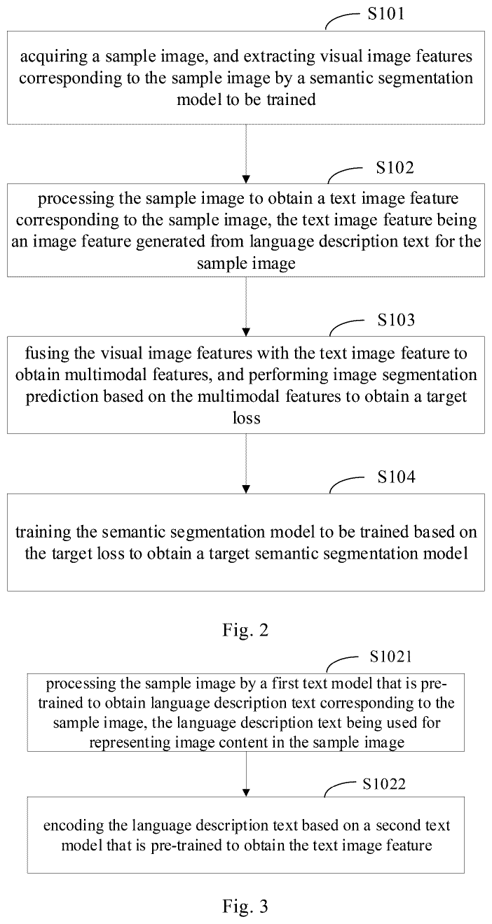

Refer to FIG. 2 which is a first flowchart of a semantic segmentation model training method according to an embodiment of the present disclosure. The method of this embodiment may be applied to electronic devices with computing capabilities, such as model training servers, terminal devices, etc. In this embodiment, a terminal device is taken as an execution subject, and the semantic segmentation model training method includes the following steps.

S101: acquiring a sample image, and extracting visual image features corresponding to the sample image by a semantic segmentation model to be trained.

For example, the sample image refers to an image used for training the semantic segmentation model to be trained, which may include a labeled sample image or an unlabeled sample image. Here, the labeled sample image is an image which is labeled in advance and has label information, while the unlabeled sample image is an image without label information. Further, the semantic segmentation model to be trained is a model configured locally on a server. For example, the semantic segmentation model to be trained may be a model that has only been initialized, or a model that has been pre-trained, which is not limited here. The semantic segmentation model to be trained may perform semantic segmentation prediction on an image input into the model and output a corresponding semantic segmentation image.

Further, the semantic segmentation model to be trained includes an encoder-decoder structure. Here, after the sample image is input into the semantic segmentation model to be trained, an encoder in the semantic segmentation model to be trained is used for performing visual feature extraction on the sample image to obtain visual feature images corresponding to the sample image, that are, visual image features; and a decoder in the semantic segmentation model to be trained is used for decoding feature images, so as to obtain a prediction result, that is, a segmentation image. The specific implementation process is introduced in detail in the following steps, and will not be further elaborated here.

S102: processing the sample image to obtain a text image feature corresponding to the sample image, the text image feature being an image feature generated from language description text for the sample image.

For example, on the other hand, feature extraction is performed on the sample image by a pre-trained text processing model, to obtain a text feature of language description text for the sample image, that is, the text image feature. Specifically, for example, the sample image shows a red car, and after the target image is processed based on the pre-trained text processing model, high-dimensional expression of the image corresponding to the natural description language “a red car”, that is, the text image feature, is obtained.

For example, as shown in FIG. 3, the specific implementation of S102 includes the following steps.

S1021: processing the sample image by a first text model that is pre-trained to obtain language description text corresponding to the sample image, the language description text being used for representing image content in the sample image.

FIG. 4 is a schematic diagram of a process of processing a sample image based on a first text model according to an embodiment of the present disclosure. As shown in FIG. 4, the first text model includes a first text encoder and a first text decoder. Firstly, code mapping is performed on the input sample image to obtain an image feature vector (image embedding), and then the image feature vector is input to the first text encoder for encoding to obtain a first text feature. Then, the first text feature is input into the first text decoder for decoding, to obtain a natural language description corresponding to the image, namely the language description text. As shown in FIG. 4, the sample image shows a red car driving, and after the processing by the first text model, the output language description text is “A red car is on the road”.

In this embodiment, the sample image is processed by the first text model, and the mapping from “image” to “text” is realized, that is, image content is abstracted in the form of text, so as to obtain information that cannot be expressed by visual features. Here, the first text model may be obtained by pre-training, and the specific training process will not be described here.

S1022: encoding the language description text based on a second text model that is pre-trained to obtain the text image feature.

Further, after the language description text based on natural language is obtained, the language description text is further encoded to be mapped into data with a number the same as that of visual image feature channels, that is, text image feature. The text image feature is a high-dimensional feature representation of the sample image. In the following steps, by combining the visual image features with the text image feature, information in the sample image may be further utilized, thus improving the efficiency of training the semantic segmentation model.

For example, the second text model is a contrastive language-image pre-training (CLIP) model, by which the mapping from natural language to image features may be realized, and its specific use method is known to those skilled in the art, which will not be further elaborated here.

S103: fusing the visual image features with the text image feature to obtain multimodal features, and performing image segmentation prediction based on the multimodal features to obtain a target loss.

For example, after processing the sample image from the visual feature dimension and the text feature dimension to obtain the corresponding visual image features and text image feature, respectively, weighted fusion may be performed on the visual image features and the text image feature, so as to obtain feature data containing information in both the visual image features and the text image feature, that is, multimodal features. In one possible implementation, fusing the visual image features with the text image feature to obtain multimodal features includes: concatenating the visual image features and the text image feature in a channel dimension to obtain the multimodal features. The process of concatenating the visual image features and the text image feature may be expressed by Formula (1):

$$F = Cat ( {F}_{v} , {F}_{t} ) \qquad ( 1 )$$

where F represents the multimodal feature, Fᵥ, represents the visual image feature, and Fₜ represents the text image feature.

Then, the multimodal features are input into the decoder in the semantic segmentation model to be trained, and the decoder in the semantic segmentation model to be trained is used for prediction to obtain a prediction result of the image segmentation, that is, the segmentation image. Then, based on the type of the sample image (labeled sample image or unlabeled sample image), a preset loss function is used for calculating a loss value corresponding to the prediction result, that is, the target loss.

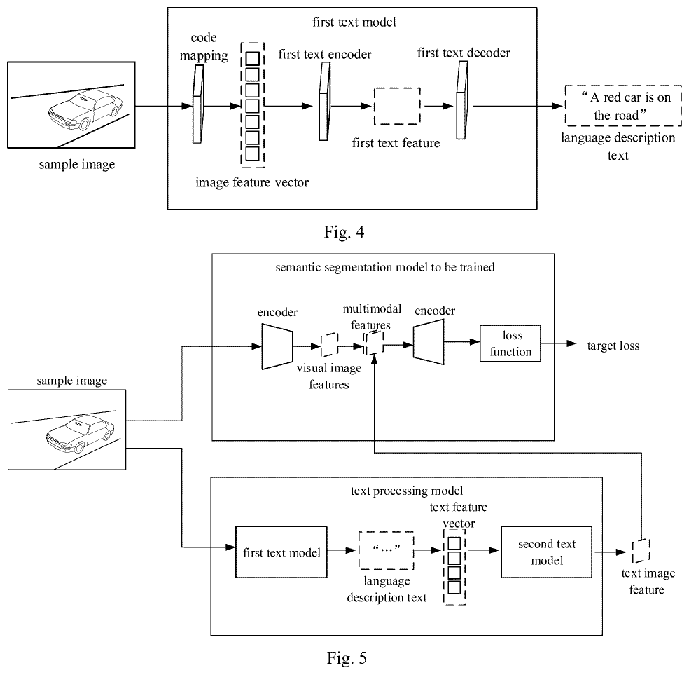

FIG. 5 is a schematic diagram of a process for acquiring a target loss according to an embodiment of the present disclosure. As shown in FIG. 5, on the one hand, after being input into the semantic segmentation model to be trained, the sample image is processed by the encoder to obtain the visual image features; on the other hand, after the sample image is input into the text processing model, the language description text is obtained by the first text model, then the language description text is encoded to obtain a text feature vector (embedding), and the text feature vector is input into the second text model for processing to obtain the text image feature. After that, the visual image features and the text image feature are fused to generate the multimodal features, the multimodal features are input into the decoder to obtain the prediction result, and the prediction result is input into the preset loss function to obtain the target loss output by the loss function.

Here, when the sample images include a labeled sample image and an unlabeled sample image, a supervised loss corresponding to labeled data and an unsupervised loss corresponding to unlabeled data may be generated by a corresponding loss function, and then the target loss is obtained based on the weighted sum of the supervised loss and the unsupervised loss. For example, weighting coefficients corresponding to the supervised loss and the unsupervised loss may be set based on specific needs and may be dynamically adjusted. For example, in the early training stage of the semantic segmentation model to be trained, the supervised loss corresponding to the labeled sample image is set to have a large weighting coefficient to improve the convergence speed of the model, and in the later training stage of the semantic segmentation model to be trained, the supervised loss corresponding to the unlabeled sample image can be set to have a large (or slightly larger) weighting coefficient, so as to make full use of the information in the unlabeled sample image and improve the performance of the semantic segmentation model to be trained.

S104: training the semantic segmentation model to be trained based on the target loss to obtain a target semantic segmentation model.

For example, after the target loss is obtained, reverse gradient propagation is performed based on the target loss, and network parameters of the semantic segmentation model to be trained are adjusted to obtain an optimized semantic segmentation model. Then, the optimized semantic segmentation model is used as a new semantic segmentation model to be trained to repeat the above process until the semantic segmentation model to be trained reaches a convergence condition, and the semantic segmentation model to be trained that is converged is the target semantic segmentation model.

This embodiment includes: acquiring a sample image, and extracting visual image features corresponding to the sample image by a semantic segmentation model to be trained; processing the sample image to obtain a text image feature corresponding to the sample image, the text image feature being an image feature generated from language description text for the sample image; fusing the visual image features with the text image feature to obtain multimodal features, and performing image segmentation prediction based on the multimodal features to obtain a target loss; and training the semantic segmentation model to be trained based on the target loss to obtain a target semantic segmentation model. In the process of training the model, on the basis of the visual features of the sample image, the text feature of the sample image is fused to generate the multimodal features, and the multimodal features are used to train the model, so that effective information in the sample image is more fully utilized, thereby improving the utilization efficiency of training samples, reducing the demand for training samples, effectively shortening the training time of the model and improving the performance of the target semantic segmentation model obtained after training.

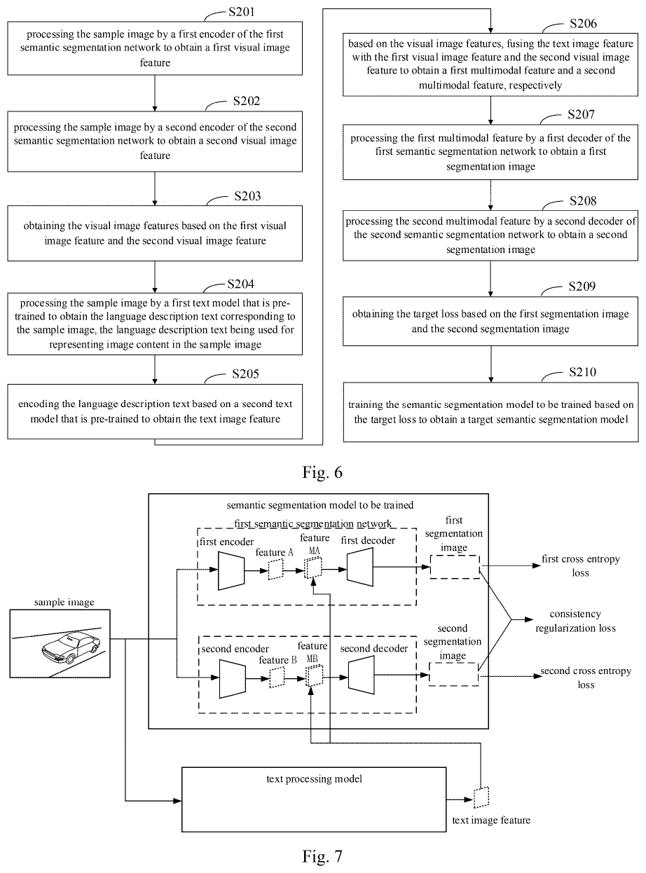

Refer to FIG. 6 which is a second flowchart of a semantic segmentation model training method according to an embodiment of the present disclosure. This embodiment refines steps S101-S103 on the basis of the embodiment shown in FIG. 2. The semantic segmentation model to be trained includes a first semantic segmentation network and a second semantic segmentation network, and the first semantic segmentation network and the second semantic segmentation network have different network parameters. The semantic segmentation model training method includes the following steps.

S201: processing the sample image by a first encoder of the first semantic segmentation network to obtain a first visual image feature.

S202: processing the sample image by a second encoder of the second semantic segmentation network to obtain a second visual image feature.

S203: obtaining the visual image features based on the first visual image feature and the second visual image feature.

For example, FIG. 7 is a schematic diagram of a semantic segmentation model to be trained according to an embodiment of the present disclosure. As shown in FIG. 7, the semantic segmentation model to be trained includes a first semantic segmentation network and a second semantic segmentation network. The first semantic segmentation network and the second semantic segmentation network both have an encoder-decoder structure, the first semantic segmentation network includes a first encoder and a first decoder connected in series, and the second semantic segmentation network includes a second encoder and a second decoder connected in series. After the same sample image is input into the first semantic segmentation network and the second semantic segmentation network, feature extraction is performed on the sample image based on the first encoder and the second encoder to obtain the corresponding first visual image feature (shown as feature A in the figure) and second visual image feature (shown as feature B in the figure). Although the first semantic segmentation network and the second semantic segmentation network have similar network structures, they have different network parameters. Therefore, after the sample image is processed by their respective encoders, the obtained first visual image feature and second visual image feature are different.

Further, after obtaining the first visual image feature and the second visual image feature, the set of the first visual image feature and the second visual image feature is the visual image features. In one possible implementation, the sample images include a labeled sample image and an unlabeled sample image. In this case, the first encoder in the first semantic segmentation network and the second encoder in the second semantic segmentation network will process the labeled sample image and the unlabeled sample image respectively, so as to obtain a first labeled visual image feature and a second labeled visual image feature corresponding to the labeled sample image, and a first unlabeled visual image feature and a second unlabeled visual image feature corresponding to the unlabeled data. Meanwhile, in the following steps, targeted processing is performed on the first labeled visual image feature, the second labeled visual image feature, the first unlabeled visual image feature and the second unlabeled visual image feature, so as to realize semi-supervised training of the model by using both the labeled sample and the unlabeled sample. The specific implementation process is introduced in detail in the following steps.

IS204: processing the sample image by a first text model that is pre-trained to obtain the language description text corresponding to the sample image, the language description text being used for representing image content in the sample image.

S205: encoding the language description text based on a second text model that is pre-trained to obtain the text image feature.

Here, S204-S205 are specific implementation steps for obtaining the text image feature, which have been introduced in detail in the embodiment shown in FIG. 2. For details, please refer to the related content in S102, which will not be repeated here.

S206: based on the visual image features, fusing the text image feature with the first visual image feature and the second visual image feature to obtain a first multimodal feature and a second multimodal feature, respectively.

S207: processing the first multimodal feature by a first decoder of the first semantic segmentation network to obtain a first segmentation image.

S208: processing the second multimodal feature by a second decoder of the second semantic segmentation network to obtain a second segmentation image.

Referring to FIG. 7, after the first visual image feature and the second visual image feature are obtained, the text image feature is concatenated with the first visual image feature and the second visual image feature channel by channel, respectively, so as to obtain the first multimodal feature (shown as feature MA in the figure) which combines the first visual image feature and the text image feature, and the second multimodal feature (shown as feature MB in the figure) which combines the second visual image feature and the text image feature. Then, based on the network structures of the first semantic segmentation network and the second semantic segmentation network, the first multimodal feature and the second multimodal feature are respectively processed by using the first decoder in the first semantic segmentation network and the second decoder in the second semantic segmentation network. The first decoder and the second decoder are used for predicting an image segmentation structure. After the above steps, image segmentation prediction corresponding to the first multimodal feature, that is, the first segmentation image, and image segmentation prediction corresponding to the second multimodal feature, that is, the second segmentation image, may be obtained.

In one possible implementation, when the sample images include a labeled sample image and an unlabeled sample image, the corresponding text image feature obtained by performing text feature extraction on the labeled sample image is a labeled text image feature, and the corresponding text image feature obtained by performing text feature extraction on the unlabeled sample image is an unlabeled text image feature. Then, the labeled text image feature is fused with the first labeled visual image feature and the second labeled visual image feature to obtain a corresponding first labeled multimodal feature and a second labeled multimodal feature, respectively. The unlabeled text image feature is fused with the first unlabeled visual image feature and the second unlabeled visual image feature to obtain a corresponding first unlabeled multimodal feature and a second unlabeled multimodal feature, respectively. Further, the first labeled multimodal feature and the first unlabeled multimodal feature are processed by the first decoder to obtain a corresponding first labeled segmentation image and a first unlabeled segmentation image, and the second labeled multimodal feature and the second unlabeled multimodal feature are processed by the second decoder to obtain a corresponding second labeled segmentation image and a second unlabeled segmentation image.

S209: obtaining the target loss based on the first segmentation image and the second segmentation image.

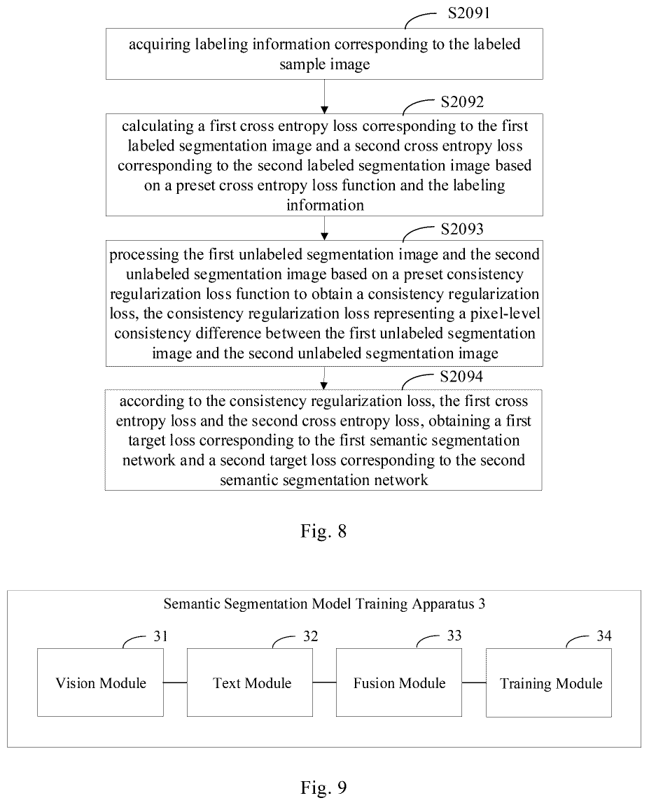

For example, as shown in FIG. 8, in one possible implementation, the sample images include a labeled sample image and an unlabeled sample image, and the specific implementation of S209 includes the following steps.

S2091: acquiring labeling information corresponding to the labeled sample image.

S2092: calculating a first cross entropy loss corresponding to the first labeled segmentation image and a second cross entropy loss corresponding to the second labeled segmentation image based on a preset cross entropy loss function and the labeling information.

For example, referring to FIG. 7, after obtaining the first labeled segmentation image and the second labeled segmentation image, firstly, the labeling information corresponding to the labeled sample image is obtained, and then based on the cross entropy loss function, the first cross entropy loss is calculated with the first labeled segmentation image and the labeling information as input parameters, and the second cross entropy loss is calculated with the second labeled segmentation image and the labeling information as input parameters. The cross entropy loss function is shown in Formula (2):

$${L}_{sup}^{l} = - \frac{1}{H \times W} {\sum }_{i = 1}^{H \times W} [ {y}_{i} log ( \hat{{y}_{ι}} ) ] \qquad ( 2 )$$

where

$${L}_{Sup}^{l}$$

represents the cross entropy loss, yᵢ represents the model prediction result, that is, the first labeled segmentation image or the second labeled segmentation image, ŷ_{ι} represents the labeling information, and H×W represents the size of the labeled segmentation image (the first labeled segmentation image or the second labeled segmentation image).

S2093: processing the first unlabeled segmentation image and the second unlabeled segmentation image based on a preset consistency regularization loss function to obtain a consistency regularization loss, the consistency regularization loss representing a pixel-level consistency difference between the first unlabeled segmentation image and the second unlabeled segmentation image.

For example, in the case of training with an unlabeled sample image, segmentation results output by two branches (the first semantic segmentation network and the second semantic segmentation network) are different. In this embodiment, a consistency supervised loss is provided for the output results of different branches, so that the output prediction results are consistent for the same input image, thus realizing the information utilization of the unlabeled sample image. Specifically, the first unlabeled segmentation image and the second unlabeled segmentation image are processed based on the consistency regularization loss function to obtain the consistency regularization loss. The consistency regularization loss function is shown in Formula (3):

$${L}_{CR}^{u} = - \frac{1}{H \times W} {\sum }_{i = 1}^{H \times W} [ {y}_{1 i} log ( {p}_{2 i} ) + {y}_{2 i} log ( {p}_{1 i} ) ] \qquad ( 3 )$$

where y₁ᵢ represents the first unlabeled segmentation image, y₂ᵢ represents the second unlabeled segmentation image, p₂ᵢ represents a pseudo label corresponding to the second unlabeled segmentation image, p₁ᵢ represents a pseudo label corresponding to the first unlabeled segmentation image, and H×W represents the size of the unlabeled segmentation image (first unlabeled segmentation image or second unlabeled segmentation image). Here, the pseudo label corresponding to the unlabeled segmentation image may be obtained by the unlabeled segmentation image of another branch. Specifically, p₂ᵢ is obtained by calculating argmax (y₁ᵢ), and p₁ᵢ is obtained by calculating argmax (y₂ᵢ).

S2094: according to the consistency regularization loss, the first cross entropy loss and the second cross entropy loss, obtaining a first target loss corresponding to the first semantic segmentation network and a second target loss corresponding to the second semantic segmentation network.

For example, after obtaining the consistency regularization loss, the first cross entropy loss and the second cross entropy loss, the first target loss corresponding to the first semantic segmentation network is obtained by calculating the weighted sum of the consistency regularization loss and the first cross entropy loss, and the second target loss corresponding to the second semantic segmentation network is obtained by calculating the weighted sum of the consistency regularization loss and the second cross entropy loss. In the following steps, the first target loss and the second target loss may be used to perform reverse gradient propagation on the first semantic segmentation network and the second semantic segmentation network respectively, so as to realize semi-supervised model training based on the labeled sample and the unlabeled sample.

S210: training the semantic segmentation model to be trained based on the target loss to obtain a target semantic segmentation model.

In this embodiment, the implementation of S210 is the same as that of S104 in the above embodiment. For details, please refer to the description of S104, which will not be repeated here.

Corresponding to the semantic segmentation model training method in the above embodiment, FIG. 9 is a structural block diagram of a semantic segmentation model training apparatus according to an embodiment of the present disclosure. For convenience of explanation, only parts related to the embodiment of the present disclosure are shown. Referring to FIG. 9, the semantic segmentation model training apparatus 3 includes:
a vision module 31, configured to acquire a sample image, and extract visual image features corresponding to the sample image by a semantic segmentation model to be trained;
a text module 32, configured to process the sample image to obtain a text image feature corresponding to the sample image, the text image feature being an image feature generated from language description text for the sample image;
a fusion module 33, configured to fuse the visual image features with the text image feature to obtain multimodal features, and perform image segmentation prediction based on the multimodal features to obtain a target loss; and
a training module 34, configured to train the semantic segmentation model to be trained based on the target loss to obtain a target semantic segmentation model.

In one embodiment of the present disclosure, the text module 32 is specifically configured to: process the sample image by a first text model that is pre-trained to obtain the language description text corresponding to the sample image, the language description text being used for representing image content in the sample image; and encode the language description text based on a second text model that is pre-trained to obtain the text image feature.

In one embodiment of the present disclosure, the first text model includes a first text encoder and a first text decoder. The text module 32, when processing the sample image by a first text model that is pre-trained to obtain the language description text corresponding to the sample image, is specifically configured to: acquire an image feature vector corresponding to the sample image; encode the image feature vector by the first text encoder to obtain a first text feature; and decode the first text feature by the first text decoder to obtain the language description text.

In one embodiment of the present disclosure, the second text model is a contrastive language-image pre-training model.

In one embodiment of the present disclosure, the fusion module 33 is specifically configured to: concatenate the visual image features and the text image feature in a channel dimension to obtain the multimodal features.

In one embodiment of the present disclosure, the semantic segmentation model to be trained includes a first semantic segmentation network and a second semantic segmentation network, and the first semantic segmentation network and the second semantic segmentation network have different network parameters; and the vision module 31 is specifically configured to: process the sample image by a first encoder of the first semantic segmentation network to obtain a first visual image feature; process the sample image by a second encoder of the second semantic segmentation network to obtain a second visual image feature; and obtain the visual image features based on the first visual image feature and the second visual image feature.

In one embodiment of the present disclosure, the fusion module 33 is specifically configured to: based on the visual image features, fuse the text image feature with the first visual image feature and the second visual image feature to obtain a first multimodal feature and a second multimodal feature, respectively; process the first multimodal feature by a first decoder of the first semantic segmentation network to obtain a first segmentation image; process the second multimodal feature by a second decoder of the second semantic segmentation network to obtain a second segmentation image; and obtain the target loss based on the first segmentation image and the second segmentation image.

In one embodiment of the present disclosure, the sample image includes a labeled sample image, and the fusion module 33, when obtaining the target loss based on the first segmentation image and the second segmentation image, is specifically configured to: acquire labeling information corresponding to the labeled sample image; calculate a first cross entropy loss corresponding to the first segmentation image and a second cross entropy loss corresponding to the second segmentation image based on a preset cross entropy loss function and the labeling information; and obtain the target loss based on the first cross entropy loss and the second cross entropy loss.

In one embodiment of the present disclosure, the sample image includes an unlabeled sample image, and the fusion module 33, when obtaining the target loss based on the first segmentation image and the second segmentation image, is specifically configured to: process the first segmentation image and the second segmentation image based on a preset consistency regularization loss function to obtain a consistency regularization loss, the consistency regularization loss representing a pixel-level consistency difference between the first segmentation image and the second segmentation image; and obtain the target loss according to the consistency regularization loss.

The vision module 31, the text module 32, the fusion module 33 and the training module 34 are connected in sequence. The semantic segmentation model training apparatus 3 provided by this embodiment can be used to implement the technical scheme of the above-mentioned method embodiment, of which implementation principle and technical effectiveness are similar to those of the method, which will not be repeated here.

An embodiment of the present disclosure provides an image semantic segmentation method, including the following steps.

S301: acquiring a target image.

S302: extracting visual image features and a text image feature corresponding to the target image, the text image feature being an image feature generated from language description text for the target image.

For example, the target image is an image to be segmented, and the visual image features and text image feature corresponding to the target image may be obtained by a preset image feature extraction model and a text processing model. Here, the specific way to extract the visual image features and text image feature corresponding to the target image is the same as the way to obtain the visual image features and text image feature of the sample image in the embodiments shown in FIG. 2-FIG. 8. For details, please refer to the relevant introduction in the above embodiments, which will not be repeated here.

S303: fusing the visual image features with the text image feature to obtain multimodal features, and performing image segmentation based on the multimodal features to obtain an image segmentation result.

For example, after obtaining the visual image features and the text image feature, the visual image features and the text image feature are fused to obtain the multimodal features. The specific implementation of this step is the same as that of obtaining the multimodal features in the embodiments shown in FIG. 2-FIG. 8. For details, please refer to the relevant introduction in the above embodiments, which will not be repeated here.

In one possible implementation, extracting the text image feature corresponding to the target image includes:

processing the target image by a first text model that is pre-trained to obtain language description text corresponding to the target image, the language description text being used for representing image content in the target image; and encoding the language description text based on a second text model that is pre-trained to obtain the text image feature.

In one possible implementation, the first text model includes a first text encoder and a first text decoder; and processing the target image by a first text model that is pre-trained to obtain language description text corresponding to the target image includes: acquiring an image feature vector corresponding to the target image; encoding the image feature vector by the first text encoder to obtain a first text feature; and decoding the first text feature by the first text decoder to obtain the language description text.

In one possible implementation, the second text model is a contrastive language-image pre-training model.

In one possible implementation, fusing the visual image features with the text image feature to obtain multimodal features includes: concatenating the visual image features and the text image feature in a channel dimension to obtain the multimodal features.

For details, please refer to the related descriptions and effects corresponding to the steps in the embodiments shown in FIG. 2-FIG. 8, which will not be repeated here.

An embodiment of the present disclosure provides an image semantic segmentation apparatus, including:
an acquisition module, configured to acquire a target image;
an extraction module, configured to extract visual image features and a text image feature corresponding to the target image, the text image feature being an image feature generated from language description text for the target image; and
a segmentation module, configured to fuse the visual image features with the text image feature to obtain multimodal features, and perform image segmentation based on the multimodal features to obtain an image segmentation result.

In one possible implementation, the extraction module, when extracting the text image feature corresponding to the target image, is specifically configured to: process the target image by a first text model that is pre-trained to obtain language description text corresponding to the target image, the language description text being used for representing image content in the target image; and encode the language description text based on a second text model that is pre-trained to obtain the text image feature.

In one possible implementation, the first text model includes a first text encoder and a first text decoder; and the extraction module, when processing the target image by a first text model that is pre-trained to obtain language description text corresponding to the target image, is specifically configured to: acquire an image feature vector corresponding to the target image; encode the image feature vector by the first text encoder to obtain a first text feature; and decode the first text feature by the first text decoder to obtain the language description text.

In one possible implementation, the second text model is a contrastive language-image pre-training model.

In one possible implementation, the segmentation module, when fusing the visual image features with the text image feature to obtain multimodal features, is specifically configured to: concatenate the visual image features and the text image feature in a channel dimension to obtain the multimodal features.

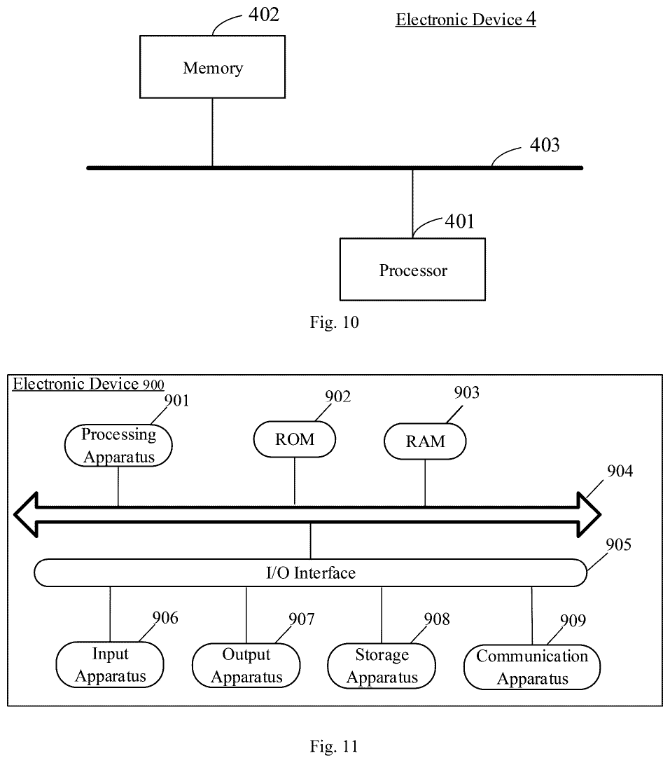

FIG. 10 is a structural schematic diagram of an electronic device according to an embodiment of the present disclosure. As shown in FIG. 10, the electronic device 4 includes:
a processor 401 and a memory 402 communicating with the processor 401;
in which the memory 402 stores computer-executed instructions; and
the processor 401 executes the computer-executed instructions stored in the memory 402, so as to implement the semantic segmentation model training method in the embodiments shown in FIG. 2-FIG. 8.

Alternatively, the processor 401 and the memory 402 are connected by a bus 403.

For details, please refer to the related descriptions and effects corresponding to the steps in the embodiments shown in FIG. 2-FIG. 8, which will not be repeated here.

Referring to FIG. 11, FIG. 11 illustrates a schematic structural diagram of an electronic device 900 suitable for implementing the embodiments of the present disclosure. The electronic device 900 may be a terminal device or a server. The terminal device may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital Television (TV), a desktop computer, or the like. The electronic device illustrated in FIG. 11 is merely an example, and should not pose any limitation to the functions and the range of use of the embodiments of the present disclosure.

As illustrated in FIG. 11, the electronic device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected through a bus 904. An input/output (I/O) interface 905 is also connected to the bus 904.

Usually, the following apparatuses may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 11 illustrates the electronic device 900 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a computer-readable medium. The computer program includes program code for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the method shown in the above-mentioned embodiments.

The computer program code for performing the operations of the present disclosure may be written in one or more programming languages or a combination thereof. The above-mentioned programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions. The units involved in the embodiments of the present disclosure may be implemented in software or hardware. Among them, the name of the unit does not constitute a limitation of the unit itself under certain circumstances. For example, the first acquisition unit can also be described as “the unit for acquiring at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In a first aspect, according to one or more embodiments of the present disclosure, a semantic segmentation model training method is provided, including:

acquiring a sample image, and extracting visual image features corresponding to the sample image by a semantic segmentation model to be trained; processing the sample image to obtain a text image feature corresponding to the sample image, the text image feature being an image feature generated from language description text for the sample image; fusing the visual image features with the text image feature to obtain multimodal features, and performing image segmentation prediction based on the multimodal features to obtain a target loss; and training the semantic segmentation model to be trained based on the target loss to obtain a target semantic segmentation model.

According to one or more embodiments of the present disclosure, the processing the sample image to obtain the text image feature corresponding to the sample image includes: processing the sample image by a first text model that is pre-trained to obtain the language description text corresponding to the sample image, the language description text being used for representing image content in the sample image; and encoding the language description text based on a second text model that is pre-trained to obtain the text image feature.

According to one or more embodiments of the present disclosure, the first text model includes a first text encoder and a first text decoder; and the processing the sample image by the first text model that is pre-trained to obtain the language description text corresponding to the sample image includes: acquiring an image feature vector corresponding to the sample image; encoding the image feature vector by the first text encoder to obtain a first text feature; and decoding the first text feature by the first text decoder to obtain the language description text.

According to one or more embodiments of the present disclosure, the second text model is a contrastive language-image pre-training model.

According to one or more embodiments of the present disclosure, the fusing the visual image features with the text image feature to obtain multimodal features includes: concatenating the visual image features and the text image feature in a channel dimension to obtain the multimodal features.

According to one or more embodiments of the present disclosure, the semantic segmentation model to be trained includes a first semantic segmentation network and a second semantic segmentation network, and the first semantic segmentation network and the second semantic segmentation network have different network parameters; and the extracting visual image features corresponding to the sample image by the semantic segmentation model to be trained includes: processing the sample image by a first encoder of the first semantic segmentation network to obtain a first visual image feature; processing the sample image by a second encoder of the second semantic segmentation network to obtain a second visual image feature; and obtaining the visual image features based on the first visual image feature and the second visual image feature.

According to one or more embodiments of the present disclosure, the fusing the visual image features with the text image feature to obtain multimodal features, and performing image segmentation prediction based on the multimodal features to obtain the target loss includes: based on the visual image features, fusing the text image feature with the first visual image feature and the second visual image feature to obtain a first multimodal feature and a second multimodal feature, respectively; processing the first multimodal feature by a first decoder of the first semantic segmentation network to obtain a first segmentation image; processing the second multimodal feature by a second decoder of the second semantic segmentation network to obtain a second segmentation image; and obtaining the target loss based on the first segmentation image and the second segmentation image.

According to one or more embodiments of the present disclosure, the sample image includes a labeled sample image, and the obtaining the target loss based on the first segmentation image and the second segmentation image includes: acquiring labeling information corresponding to the labeled sample image; calculating a first cross entropy loss corresponding to the first segmentation image and a second cross entropy loss corresponding to the second segmentation image based on a preset cross entropy loss function and the labeling information; and obtaining the target loss based on the first cross entropy loss and the second cross entropy loss.

According to one or more embodiments of the present disclosure, the sample image includes an unlabeled sample image, and the obtaining the target loss based on the first segmentation image and the second segmentation image includes: processing the first segmentation image and the second segmentation image based on a preset consistency regularization loss function to obtain a consistency regularization loss, the consistency regularization loss representing a pixel-level consistency difference between the first segmentation image and the second segmentation image; and obtaining the target loss according to the consistency regularization loss.

In a second aspect, according to one or more embodiments of the present disclosure, an image semantic segmentation method is provided, including:

acquiring a target image; extracting visual image features and a text image feature corresponding to the target image, the text image feature being an image feature generated from language description text for the target image; and fusing the visual image features with the text image feature to obtain multimodal features, and performing image segmentation based on the multimodal features to obtain an image segmentation result.

In one possible implementation, extracting the text image feature corresponding to the target image includes:

processing the target image by a first text model that is pre-trained to obtain language description text corresponding to the target image, the language description text being used for representing image content in the target image; and encoding the language description text based on a second text model that is pre-trained to obtain the text image feature.

In one possible implementation, the first text model includes a first text encoder and a first text decoder; and processing the target image by a first text model that is pre-trained to obtain language description text corresponding to the target image includes: acquiring an image feature vector corresponding to the target image; encoding the image feature vector by the first text encoder to obtain a first text feature; and decoding the first text feature by the first text decoder to obtain the language description text.

In one possible implementation, the second text model is a contrastive language-image pre-training model.

In one possible implementation, fusing the visual image features with the text image feature to obtain multimodal features includes: concatenating the visual image features and the text image feature in a channel dimension to obtain the multimodal features.

In a third aspect, according to one or more embodiments of the present disclosure, a semantic segmentation model training apparatus is provided, including:
a vision module, configured to acquire a sample image, and extract visual image features corresponding to the sample image by a semantic segmentation model to be trained;
a text module, configured to process the sample image to obtain a text image feature corresponding to the sample image, the text image feature being an image feature generated from language description text for the sample image;
a fusion module, configured to fuse the visual image features with the text image feature to obtain multimodal features, and perform image segmentation prediction based on the multimodal features to obtain a target loss; and
a training module, configured to train the semantic segmentation model to be trained based on the target loss to obtain a target semantic segmentation model.

In one embodiment of the present disclosure, the text module is specifically configured to: process the sample image by a first text model that is pre-trained to obtain the language description text corresponding to the sample image, the language description text being used for representing image content in the sample image; and encode the language description text based on a second text model that is pre-trained to obtain the text image feature.

In one embodiment of the present disclosure, the first text model includes a first text encoder and a first text decoder. The text module, when processing the sample image by a first text model that is pre-trained to obtain the language description text corresponding to the sample image, is specifically configured to: acquire an image feature vector corresponding to the sample image; encode the image feature vector by the first text encoder to obtain a first text feature; and decode the first text feature by the first text decoder to obtain the language description text.

In one embodiment of the present disclosure, the second text model is a contrastive language-image pre-training model.

In one embodiment of the present disclosure, the fusion module is specifically configured to: concatenate the visual image features and the text image feature in a channel dimension to obtain the multimodal features.

In one embodiment of the present disclosure, the semantic segmentation model to be trained includes a first semantic segmentation network and a second semantic segmentation network, and the first semantic segmentation network and the second semantic segmentation network have different network parameters; and the vision module is specifically configured to: process the sample image by a first encoder of the first semantic segmentation network to obtain a first visual image feature; process the sample image by a second encoder of the second semantic segmentation network to obtain a second visual image feature; and obtain the visual image features based on the first visual image feature and the second visual image feature.

In one embodiment of the present disclosure, the fusion module is specifically configured to: based on the visual image features, fuse the text image feature with the first visual image feature and the second visual image feature to obtain a first multimodal feature and a second multimodal feature, respectively; process the first multimodal feature by a first decoder of the first semantic segmentation network to obtain a first segmentation image; process the second multimodal feature by a second decoder of the second semantic segmentation network to obtain a second segmentation image; and obtain the target loss based on the first segmentation image and the second segmentation image.

In one embodiment of the present disclosure, the sample image includes a labeled sample image, and the fusion module, when obtaining the target loss based on the first segmentation image and the second segmentation image, is specifically configured to: acquire labeling information corresponding to the labeled sample image; calculate a first cross entropy loss corresponding to the first segmentation image and a second cross entropy loss corresponding to the second segmentation image based on a preset cross entropy loss function and the labeling information; and obtain the target loss based on the first cross entropy loss and the second cross entropy loss.

In one embodiment of the present disclosure, the sample image includes an unlabeled sample image, and the fusion module, when obtaining the target loss based on the first segmentation image and the second segmentation image, is specifically configured to: process the first segmentation image and the second segmentation image based on a preset consistency regularization loss function to obtain a consistency regularization loss, the consistency regularization loss representing a pixel-level consistency difference between the first segmentation image and the second segmentation image; and obtain the target loss according to the consistency regularization loss.

In a fourth aspect, according to one or more embodiments of the present disclosure, an image semantic segmentation apparatus is provided, including:
an acquisition module, configured to acquire a target image;
an extraction module, configured to extract visual image features and a text image feature corresponding to the target image, the text image feature being an image feature generated from language description text for the target image; and
a segmentation module, configured to fuse the visual image features with the text image feature to obtain multimodal features, and perform image segmentation based on the multimodal features to obtain an image segmentation result.

According to one or more embodiments of the present disclosure, the extraction module, when extracting the text image feature corresponding to the target image, is specifically configured to: process the target image by a first text model that is pre-trained to obtain language description text corresponding to the target image, the language description text being used for representing image content in the target image; and encode the language description text based on a second text model that is pre-trained to obtain the text image feature.

According to one or more embodiments of the present disclosure, the first text model includes a first text encoder and a first text decoder; and the extraction module, when processing the target image by a first text model that is pre-trained to obtain language description text corresponding to the target image, is specifically configured to: acquire an image feature vector corresponding to the target image; encode the image feature vector by the first text encoder to obtain a first text feature; and decode the first text feature by the first text decoder to obtain the language description text.

According to one or more embodiments of the present disclosure, the second text model is a contrastive language-image pre-training model.

According to one or more embodiments of the present disclosure, the segmentation module, when fusing the visual image features with the text image feature to obtain multimodal features, is specifically configured to: concatenate the visual image features and the text image feature in a channel dimension to obtain the multimodal features.

In a fifth aspect, according to one or more embodiments of the present disclosure, an electronic device is provided, including:
a processor and a memory communicating with the processor,
in which the memory stores computer-executed instructions, and
the processor executes the computer-executed instructions stored in the memory, so as to implement the semantic segmentation model training method described in the first aspect and various possible designs of the first aspect as above.

In a sixth aspect, according to one or more embodiments of the present disclosure, a computer-readable storage medium is provided, in which computer-executed instructions are stored in the computer-readable storage medium, and when the computer-executed instructions are executed by a processor, the semantic segmentation model training method described in the first aspect and various possible designs of the first aspect as above is implemented.

In a seventh aspect, according to one or more embodiments of the present disclosure, a computer program product is provided, including computer programs, wherein the computer programs, when executed by a processor, implement the semantic segmentation model training method described in the first aspect and various possible designs of the first aspect as above.

In an eighth aspect, according to one or more embodiments of the present disclosure, a computer program is provided, the computer program is used for implementing the semantic segmentation model training method described in the first aspect and various possible designs of the first aspect as above.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A semantic segmentation model training method, comprising:
acquiring a sample image, and extracting visual image features corresponding to the sample image by a semantic segmentation model to be trained;
processing the sample image to obtain a text image feature corresponding to the sample image, the text image feature being an image feature generated from language description text for the sample image;
fusing the visual image features with the text image feature to obtain multimodal features, and performing image segmentation prediction based on the multimodal features to obtain a target loss; and
training the semantic segmentation model to be trained based on the target loss to obtain a target semantic segmentation model.

2. The method according to claim 1, wherein the processing the sample image to obtain the text image feature corresponding to the sample image comprises:
processing the sample image by a first text model that is pre-trained to obtain the language description text corresponding to the sample image, the language description text being used for representing image content in the sample image; and
encoding the language description text based on a second text model that is pre-trained to obtain the text image feature.

3. The method according to claim 2, wherein the first text model comprises a first text encoder and a first text decoder; and
the processing the sample image by the first text model that is pre-trained to obtain the language description text corresponding to the sample image comprises:
acquiring an image feature vector corresponding to the sample image;
encoding the image feature vector by the first text encoder to obtain a first text feature; and
decoding the first text feature by the first text decoder to obtain the language description text.

4. The method according to claim 2, wherein the second text model is a contrastive language-image pre-training model.

5. The method according to claim 1, wherein the fusing the visual image features with the text image feature to obtain multimodal features comprises:
concatenating the visual image features and the text image feature in a channel dimension to obtain the multimodal features.

6. The method according to claim 1, wherein the semantic segmentation model to be trained comprises a first semantic segmentation network and a second semantic segmentation network, and the first semantic segmentation network and the second semantic segmentation network have different network parameters; and
the extracting visual image features corresponding to the sample image by the semantic segmentation model to be trained comprises:
processing the sample image by a first encoder of the first semantic segmentation network to obtain a first visual image feature;
processing the sample image by a second encoder of the second semantic segmentation network to obtain a second visual image feature; and
obtaining the visual image features based on the first visual image feature and the second visual image feature.

7. The method according to claim 6, wherein the fusing the visual image features with the text image feature to obtain multimodal features, and performing image segmentation prediction based on the multimodal features to obtain the target loss comprises:
based on the visual image features, fusing the text image feature with the first visual image feature and the second visual image feature to obtain a first multimodal feature and a second multimodal feature, respectively;
processing the first multimodal feature by a first decoder of the first semantic segmentation network to obtain a first segmentation image;
processing the second multimodal feature by a second decoder of the second semantic segmentation network to obtain a second segmentation image; and
obtaining the target loss based on the first segmentation image and the second segmentation image.

8. The method according to claim 7, wherein the sample image comprises a labeled sample image, and the obtaining the target loss based on the first segmentation image and the second segmentation image comprises:
acquiring labeling information corresponding to the labeled sample image;
calculating a first cross entropy loss corresponding to the first segmentation image and a second cross entropy loss corresponding to the second segmentation image based on a preset cross entropy loss function and the labeling information; and
obtaining the target loss based on the first cross entropy loss and the second cross entropy loss.

9. The method according to claim 7, wherein the sample image comprises an unlabeled sample image, and the obtaining the target loss based on the first segmentation image and the second segmentation image comprises:
processing the first segmentation image and the second segmentation image based on a preset consistency regularization loss function to obtain a consistency regularization loss, the consistency regularization loss representing a pixel-level consistency difference between the first segmentation image and the second segmentation image; and
obtaining the target loss according to the consistency regularization loss.

10. A image semantic segmentation method, comprising:
acquiring a target image;
extracting visual image features and a text image feature corresponding to the target image, the text image feature being an image feature generated from language description text for the target image; and
fusing the visual image features with the text image feature to obtain multimodal features, and performing image segmentation based on the multimodal features to obtain an image segmentation result.

11. (canceled)

12. An electronic device, comprising a processor and a memory communicating with the processor, wherein
the memory stores computer-executed instructions, and
the processor executes the computer-executed instructions stored in the memory, so as to implement a semantic segmentation model training method, which comprises:
acquiring a sample image, and extracting visual image features corresponding to the sample image by a semantic segmentation model to be trained;
processing the sample image to obtain a text image feature corresponding to the sample image, the text image feature being an image feature generated from language description text for the sample image;
fusing the visual image features with the text image feature to obtain multimodal features, and performing image segmentation prediction based on the multimodal features to obtain a target loss; and
training the semantic segmentation model to be trained based on the target loss to obtain a target semantic segmentation model.

13. A non-transitory computer-readable storage medium, wherein computer-executed instructions are stored in the computer-readable storage medium, and when the computer-executed instructions are executed by a processor, the semantic segmentation model training method according to claim 1 is implemented.

14-15. (canceled)

16. The electronic device according to claim 12, wherein the processing the sample image to obtain the text image feature corresponding to the sample image comprises:
processing the sample image by a first text model that is pre-trained to obtain the language description text corresponding to the sample image, the language description text being used for representing image content in the sample image; and
encoding the language description text based on a second text model that is pre-trained to obtain the text image feature.

17. The electronic device according to claim 16, wherein the first text model comprises a first text encoder and a first text decoder; and
the processing the sample image by the first text model that is pre-trained to obtain the language description text corresponding to the sample image comprises:
acquiring an image feature vector corresponding to the sample image;
encoding the image feature vector by the first text encoder to obtain a first text feature; and
decoding the first text feature by the first text decoder to obtain the language description text.

18. The electronic device according to claim 16, wherein the second text model is a contrastive language-image pre-training model.

19. The electronic device according to claim 12, wherein the fusing the visual image features with the text image feature to obtain multimodal features comprises:
concatenating the visual image features and the text image feature in a channel dimension to obtain the multimodal features.

20. The electronic device according to claim 12, wherein the semantic segmentation model to be trained comprises a first semantic segmentation network and a second semantic segmentation network, and the first semantic segmentation network and the second semantic segmentation network have different network parameters; and
the extracting visual image features corresponding to the sample image by the semantic segmentation model to be trained comprises:
processing the sample image by a first encoder of the first semantic segmentation network to obtain a first visual image feature;
processing the sample image by a second encoder of the second semantic segmentation network to obtain a second visual image feature; and
obtaining the visual image features based on the first visual image feature and the second visual image feature.

21. The electronic device according to claim 20, wherein the fusing the visual image features with the text image feature to obtain multimodal features, and performing image segmentation prediction based on the multimodal features to obtain the target loss comprises:
based on the visual image features, fusing the text image feature with the first visual image feature and the second visual image feature to obtain a first multimodal feature and a second multimodal feature, respectively;
processing the first multimodal feature by a first decoder of the first semantic segmentation network to obtain a first segmentation image;
processing the second multimodal feature by a second decoder of the second semantic segmentation network to obtain a second segmentation image; and
obtaining the target loss based on the first segmentation image and the second segmentation image.

22. The electronic device according to claim 21, wherein the sample image comprises a labeled sample image, and the obtaining the target loss based on the first segmentation image and the second segmentation image comprises:
acquiring labeling information corresponding to the labeled sample image;
calculating a first cross entropy loss corresponding to the first segmentation image and a second cross entropy loss corresponding to the second segmentation image based on a preset cross entropy loss function and the labeling information; and
obtaining the target loss based on the first cross entropy loss and the second cross entropy loss.

23. The electronic device according to claim 21, wherein the sample image comprises an unlabeled sample image, and the obtaining the target loss based on the first segmentation image and the second segmentation image comprises:
processing the first segmentation image and the second segmentation image based on a preset consistency regularization loss function to obtain a consistency regularization loss, the consistency regularization loss representing a pixel-level consistency difference between the first segmentation image and the second segmentation image; and
obtaining the target loss according to the consistency regularization loss.
